(19) United States
(12) Patent Application Publication
(10) Pub. No.: US 2026/0228096 A1
(43) Pub. Date: Aug. 6, 2026

(54) AUTOMATED PREEMPTIVE RANKED FAILOVER

(71) Applicant: Hitachi Vantara LLC, Santa Clara, CA (US)

(72) Inventors: James STORMONT, Corfe Mullen (GB); Fabrice HELLIKER, Broadstone (GB); Simon CHAPPELL, Bournemouth (GB)

(21) Appl. No.: 19/151,657

(22) PCT Filed: Feb. 10, 2023
(86) PCT No.: PCT/US2023/012776

§ 371 Date: Jul. 29, 2025

(51) Int. Cl. G06F 11/20

(52) U.S. Cl. CPC G06F 11/203

(57) ABSTRACT

In some examples, a computing device receives first information related to conditions of a first computing system and second information related to conditions of a second computing system. The computing device may determine, based at least on the first information, that a threat level related to a possible failure at the first computing system corresponds to a threat level condition for performing a preemptive failover. Based at least on the second information, the computing system may determine that a threat level at the second computing system is lower than the threat level at the first computing system. Based at least on determining that the threat level at the second computing system is lower than the threat level at the first computing system, the computing device sends an instruction to the first computing system to initiate preemptive failover from the first computing system to the second computing system.

### TECHNICAL FIELD

This disclosure relates to the technical field of data storage.

### BACKGROUND

For maintaining continuity and high availability of applications and data, storage systems and other computing systems may include failover technologies to enable the workload to be transferred from a first site to a second site when there is a failure at a first site. The failover operation may typically be triggered at a point in time when the first computing system has failed, or may be triggered manually by an administrative user, such as after the failure has occurred. Thus, conventional failover techniques may result in a period of downtime, as even automatically triggered failover based on a failed system can require a transfer and recovery period, and can also result in data consistency issues. Additionally, because failover may typically occur after the primary system goes down, the process of recovery may be further complicated when the primary site is restored to operation, such as in the case that both sites might attempt to handle the workload.

### SUMMARY

In some implementations, a computing device receives first information related to conditions of a first computing system and second information related to conditions of a second computing system. The first computing system can communicate over a network with the second computing system. The computing device may determine, based at least on the first information, that a threat level related to a possible failure at the first computing system corresponds to a threat level condition for performing a preemptive failover from the first computing system. Based at least on the second information, the computing system may determine that a threat level at the second computing system is lower than the threat level at the first computing system. Based at least on determining that the threat level at the second computing system is lower than the threat level at the first computing system, the computing device sends an instruction to the first computing system to initiate preemptive failover from the first computing system to the second computing system.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates an example architecture of a system able to detect events and perform preemptive failover according to some implementations.

FIG. 2 illustrates an example logical arrangement of the failover program configured for monitoring for events and preemptively performing failover when appropriate according to some implementations herein.

FIG. 3 is a flow diagram illustrating an example process for preemptively performing failover according to some implementations.

FIG. 4 illustrates select components of an example computing system that may be used to implement some of the functionality of the systems described herein.

### DESCRIPTION OF THE EMBODIMENTS

Some implementations herein are directed to techniques and arrangements for generating and employing machine learning and/or heuristics models for detecting an event that might threaten operation of a computing system, and preemptively triggering a failover process based at least on detecting the event. Examples of events that may trigger the preemptive failover process may include events detected based on one or more sensors associated with the computing system, such as a temperature escalation, power loss, network outage, security breach, intruder detection, a fire alarm, detection of excess humidity, and the occurrence of an earthquake. Additional examples of events that may trigger the preemptive failover process may include events detected based on external condition information received from one or more computing devices such as a brownout or blackout warning, a tornado warning; a tsunami warning, a hurricane warning, lightning, or a heat wave. Other examples of possible events may include notification of unavailability of sufficient staffing, notification of security risk (e.g., local riots, war, or the like), or an unexpected change in operating costs (e.g., cost of energy, cost of cooling).

The failover process may be a fully automated failover performed between a primary system and a secondary system. For instance, the processing workload at a first computing system may be preemptively transferred to a second computing system at a different site location based on a detected threat level at the first computing system. For instance, the system may determine that the threat level at the first computing system satisfies a threshold or otherwise warrants failover to the second computing system. Further, in the implementations herein, before determining to perform the preemptive failover to the second computing system, the system may check the current threat level at the second computing system and any other available computing systems to ensure that the threat level at the computing system that is the target of the failover is lower than the threat level at the first computing system. For instance, the examples herein may take into consideration an indication of where current workloads are being handled and relative threat level assessments at different computing system locations within the overall system.

In some examples, a human administrative user may first be prompted to approve a preemptive failover process prior to it being performed. In other examples, administrative user approval is not required before initiating the preemptive failover process, and the failover process may be initiated automatically, such as based on a determination made by a failover decision engine. For instance, the failover decision engine may include a machine-learning model and/or a heuristics model configured for determining, based at least on comparing indications of current threat levels at each computing system, to initiate a preemptive failover from a first computing system to a second computing system. Further, in some cases the preemptive failover herein may alternatively be referred to as a switchover that is performed based on automated comparison and weighing of the current threat levels at each of the computing systems in an overall system including a plurality of computing systems located at different geographical locations.

For discussion purposes, some example implementations are described in the environment of a plurality of computing systems that are in communication with each other, and that are monitored for threats for enabling preemptive failover from one computing system to another based on detected threat levels. However, implementations herein are not limited to the particular examples provided, and may be extended to other types of computing system architectures, other types of threats, other types of storage environments, other types of client configurations, other types of data, and so forth, as will be apparent to those of skill in the art in light of the disclosure herein.

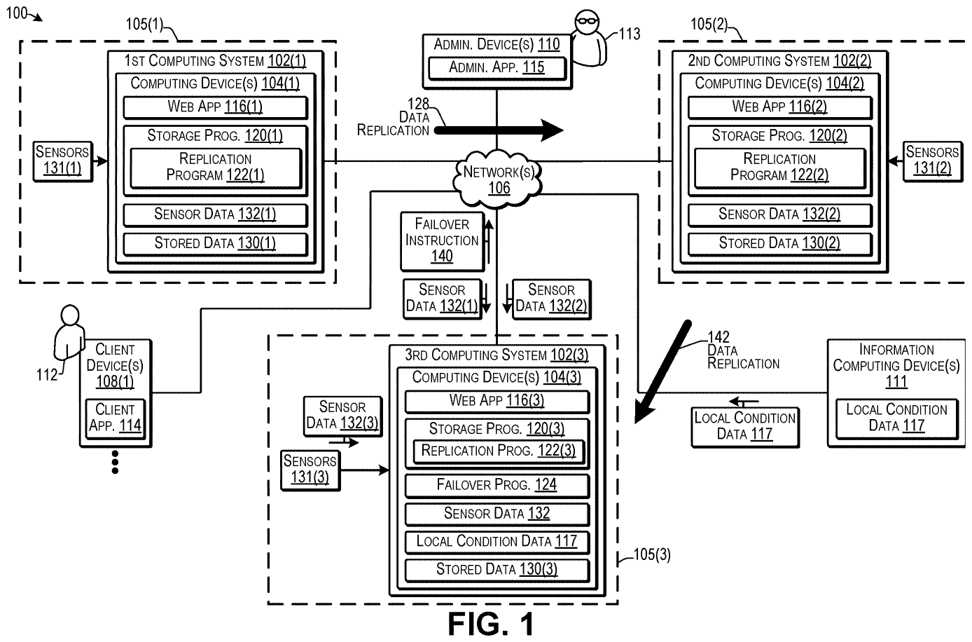

FIG. 1 illustrates an example architecture of a system 100 able to detect events and perform preemptive failover according to some implementations. The system 100 includes a plurality of computing systems 102 that each include one or more computing devices 104, respectively. For example, a first computing system 102(1) includes one or more computing devices 104(1), a second computing system 102(2) includes one or more computing devices 104(2), and a third computing system 102(3) includes one or more computing devices 104(3). In some examples, a plurality of the computing devices 104 at each computing system 102 may form a cluster of computing devices, or the like, but implementations are not limited to any particular configuration of the computing systems 104.

The computing systems 102 may be located at respective sites 105 and may be able to communicate with each other through one or more networks 106. For example, the first computing system 102(1) may be physically located at a first site 105(1) at a first geographic location, the second computing system 102(2) may be physically located at a second site 105(2) at a second geographic location that is remote from the first geographic location, and the third computing system 102(3) may be physically located at a third site 105(3) that is remote from the first geographic location and the second geographic location. For instance, the second and third geographic locations may be sufficiently remote from the first geographic location and each other, such as in another city, another state, another country, etc., so that a disaster or other failure that affects the first computing system 102(1) at the first site 105(1) is not likely to affect the second computing system 102(2) at the second site 105(2), or the third computing system 102(3) at the third site 105(3), and vice versa. Accordingly, this topology provides redundancy in the data that is stored on the computing systems 102(1)-102(3) to avoid catastrophic loss of data.

In some examples, the computing systems 102 are also able to communicate over the one or more networks 106 with one or more client devices 108, one or more administrative devices 110, and one or more information computing devices 111. For instance, the computing systems 102 may include access nodes, server nodes, management nodes, and/or other types of service nodes that provide the client devices 108 with storage services for enabling the client devices 108 to store data with one or more of the computing systems 102, as well as performing other management and control functions, as discussed additionally below. The client device(s) 108, administrative device(s) 110, and the information computing device(s) 111 may be any of various types of computing devices, as discussed additionally below.

The one or more networks 106 may include any suitable network, including a wide area network, such as the Internet; a local area network (LAN), such as an intranet; a wireless network, such as a cellular network, a local wireless network, such as Wi-Fi, and/or short-range wireless communications, such as BLUETOOTH®; a wired network including Fibre Channel, fiber optics, Ethernet, or any other such network, a direct wired connection, or any combination thereof. Accordingly, the one or more networks 106 may include both wired and/or wireless communication technologies. Components used for such communications can depend at least in part upon the type of network, the environment selected, or both. Protocols for communicating over such networks are well known and will not be discussed herein in detail. As one example, the network(s) 106 may include a private network, such as a LAN, storage area network (SAN), or Fibre Channel network. Additionally, the network(s) 106 may include a public network that may include the Internet, or a combination of public and private networks. Implementations herein are not limited to any particular type of network as the networks 106.

In some examples, the computing systems 102 may be configured to provide storage and data management services to client users 112 via the client device(s) 108, respectively. As several non-limiting examples, the client users 112 may include users performing functions for businesses, enterprises, organizations, governmental entities, academic entities, or the like, and which may include storage of very large quantities of data in some examples. Additionally, in some examples, the client users 112 may include administrative users that use the client devices 108 for managing one or more of the computing systems 102. Nevertheless, implementations herein are not limited to any particular use or application for the system 100 and the other example systems and arrangements described herein. For instance, in some examples, the client devices 108 may not be included or may be entirely different types of client devices.

Each client device 108 may be any suitable type of computing device such as a desktop, laptop, tablet computing device, mobile device, smart phone, wearable device, terminal, and/or any other type of computing device able to send data over a network. Client users 112 may be associated with client device(s) 108 such as through a respective user account, user login credentials, or the like. Furthermore, the client device(s) 108 may be configured to communicate with the computing systems 102 through the one or more networks 106, through separate networks, or through any other suitable type of communication connection. Numerous other variations will be apparent to those of skill in the art having the benefit of the disclosure herein.

In some implementations, each client device 108 may include a respective instance of a client application 114 that may execute on the client device 108, such as for communicating with a web application 116 executable on one or more of the computing devices 104 of the computing systems 102. The client application may be configured for sending user data for storage at the computing systems 102 and/or for receiving stored data from the computing systems 102 through a data instruction, such as a write operation, read operation, delete operation, or the like. In some cases, the application 114 may include a browser or may operate through a browser, while in other cases, the application 114 may include any other type of application having communication functionality enabling communication with the web application 116 or other application on the computing systems 102 over the one or more networks 106.

In addition, the administrator device 110 may be any suitable type of computing device such as a desktop, laptop, tablet computing device, mobile device, smart phone, wearable device, terminal, server, and/or any other type of computing device able to send data over a network. For instance, an administrative user 113 may be associated with a respective administrator device 110, such as through a respective administrator account, administrator login credentials, or the like. Furthermore, the administrator device 110 may be able to communicate with the service computing device(s) 102 through the one or more networks 106, through separate networks, or through any other suitable type of communication connection.

Additionally, each administrative device 110 may include a respective instance of an administrative application 115 that may execute on the administrator device 110, such as for communicating with a management module of the web application 116 executable on the computing device(s) 104, such as for sending management instructions for managing the system 100 and/or for sending management data for storage by the computing system(s) 102 and/or for receiving stored management data from the computing system(s) 102, such as through a management instruction or the like. In some cases, the administrative application 115 may include a browser or may operate through a browser, while in other cases, the administrative application 115 may include any other type of application having communication functionality enabling communication with the web application 116 over the one or more networks 106. Further, in the case of an administrative user 113, the web application 116 may provide remote management functionality. Alternatively, in other examples, any of numerous other types of software arrangements may be employed for performing these functions, as will be apparent to those of skill in the art having the benefit of the disclosure herein.

The information computing device(s) 111 may be servers, such as web servers, or any other suitable type of computing device able to provide information over a network. For example, the information computing devices 111 may provide local condition data 117, such as weather forecasts, government-provided information, news feeds, or the like, that is relevant to one or more of the computing systems 102 such as to provide information indicative of events likely to trigger a failover. Examples of the local condition information may include warnings regarding a brownout or blackout, a tornado; a tsunami, a hurricane or similar severe storm, lightning, a heat wave, or a notification of a security risk (e.g., local riots, war, local emergencies, evacuations, disasters, or the like). In some examples, a plurality of information computing devices 111 may be configured to provide one or more of the above-discussed types of information as data feeds, push notifications, responses to periodic requests, or the like.

The computing systems 102(1), 102(2), and 102(3), may each execute instances of a storage program 120(1), 120(2), and 102(3), respectively, which may include, or which may access or otherwise execute instances of a replication program 122(1), 122(2), and 122(3), respectively. In addition, in the illustrated example, at least the third computing system 102(3) may execute a failover program 124 configured to monitor. In some examples, the third computing system 124(3) may be a cloud-based computing system that operates on computing devices provided by a commercial computing service provider such as AMAZON WEB SERVICES and/or SIMPLE STORAGE SERVICE, MICROSOFT AZURE, GOOGLE CLOUD; ORACLE CLOUD, IBM CLOUD, and the like. Additionally, in some examples, the first and second computing systems 102(1) and 102(2) may be privately owned by an enterprise or other entity, may also be operated on a commercial computing platform, or may be composed of a combination thereof. Alternatively, in some examples, the third computing system 102(3) may also be privately owned or maintained, such as by the same entity as computing systems 102(1) and 102(2). Additionally, in some examples, rather than being executed at the third computing system 102(3), the failover program 124 may be executed at a fourth computing system or other suitable computing device (not shown) that is geographically remote from the computing systems 102(1)-102(3) to ensure operation of the failover program 124 survives failure of any one of the computing systems 102(1)-102(3). As yet another alternative, the failover program may be executed at each of the computing systems 102(1)-102(3) or at any one of the computing systems 102(1)-102(3). Additional details of the failover program 124 are discussed below.

The storage program 120 may provide access to stored data 130 at each computing system 102. In some examples, the stored data 130 may be stored data objects that include object data and corresponding metadata associated with the object data of each data object. However, in other examples, other types of data may be included as the stored data 130. Consequently, implementations herein are not limited to any particular type of data as the stored data 130.

The storage program 120(1) may access, store, and manage the stored data 130(1); the storage program 120(2) may access, store, and manage the stored data 130(2); and the storage program 120(3) may access, store, and manage the stored data 130(3). For instance, the storage program 120 may receive data from the client devices 108, may store the data as the stored data 130 on one or more storage devices associated with the respective computing system 102, and/or may retrieve and send requested data to the client devices 108, such as in response to a client read request, or the like.

In addition, the storage program 120 may include, may execute, may access, or may otherwise coexist with the data replication program 122, which may be configured to perform data replication at least from the first computing system 102(1) to the second computing system 102(2), as indicated by data replication link 128, between the computing system 102(1) and the computing system 102(2). Additionally, in some examples, the computing system 102(1) may also perform replication to the third computing system 102(3), or to another computing system (not shown). In some cases, the second computing system 102(2) and the third computing system 102(3) may also be configured to perform replication to the other computing systems 102, and/or to other computing systems not shown in this example. Further, the data replication program 122 may configure the computing systems 102(1)-102(3) to perform asynchronous or synchronous data replication between at least the computing system 102(1) and 102(2).

The computing systems 102 may each include sensors 131. For example, the first computing system 102(1) may include the sensors 131(1) that provide sensor data 132(1), the second computing system 102(2) include the sensors 131(2) that provide the sensor data 132(2), and the third computing system 102(3) may include the sensors 131(3) that provide the sensor data 132(3). Examples of sensors 131 may include temperature sensors, smoke detectors, seismographs, electrical power sensors, alarm systems, humidity sensors, network monitoring devices, and so forth. Implementations herein are not limited to any particular types of sensors 131.

The sensor data 132 may be sent to the failover program 124. For instance, in some cases, the computing systems 102 may send the sensor data 132 to the computing device that is executing the failover program 124. In other examples, some or all of the sensors 131 may be configured to communicate directly over the one or more networks 106 with the computing device executing the failover program 124. In either event, in the illustrated example, the computing device 104(3) executing the failover program 124 at the third computing system 102(3) receives sensor data 131(1) indicating conditions at the first computing system 102(1), and receives sensor data 131(2) indicating conditions at the second computing system 102(2). The computing device 104(3) executing the failover program 124 at the third computing system 102(3) may also receive sensor data 132(3) from the sensors 131(3) that are located at the third computing site 105(3).

In addition, as mentioned above, the computing device 104(3) executing the failover program 124 at the third computing system 102(3) may receive the local condition data 117 from the information computing devices 111. The local condition data 117 may include local condition data 117 for the first computing system 102(1) at the first site 105(1), local condition data 117 for the second computing system 102(2) at the second site 105(2), as well as local condition data 117 for the third computing system 102(3) at the third site 105(3).

In the illustrated example of FIG. 1, suppose that one of the computing devices 104(3) executes the failover program 124 to receive the first sensor data 132(1), the second sensor data 132(2), and the third sensor data 132(3), and to further receive the local condition data 117 for the first, second, and third computing systems 102(1), 102(2), and 102(3). In addition, the computing device 104(3) may receive other information that may be relevant to failover considerations, such as information technology (IT) systems information or the like. Examples of IT systems information may include information related to unavailability of sufficient staffing, notifications of security hardware or software security breaches, e.g., viruses, malware, denial of service attacks, ransomware attacks, and so forth. In some cases, at least some of the IT systems information may be provided by the administrative user 113 via the administrative device 110, or the like.

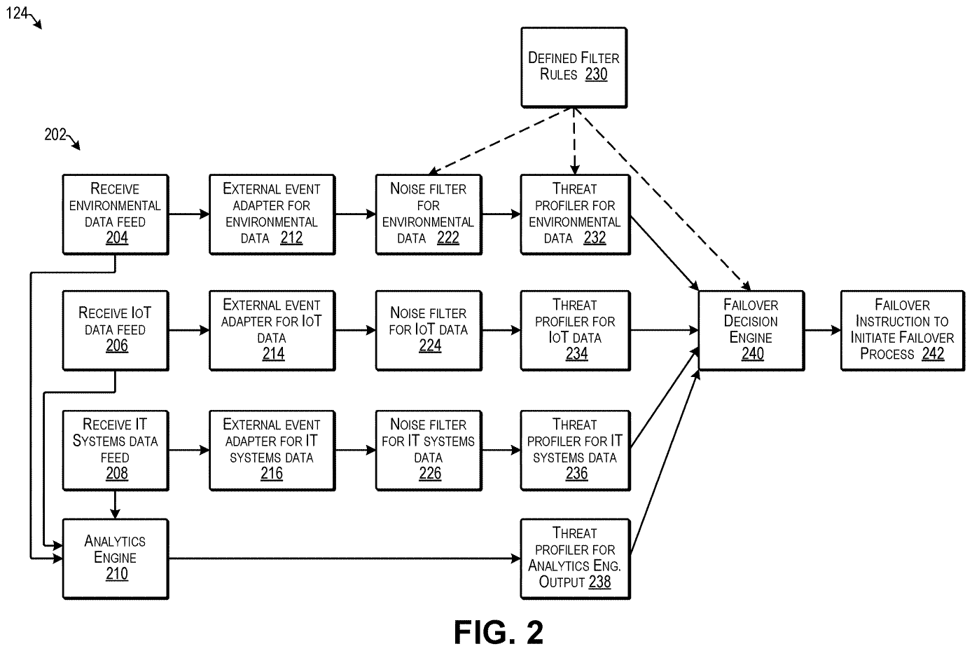

As discussed additionally below with respect to FIG. 2, the failover program 124 may identify, from the receive information any events that are likely to pose a threat to any of the computing systems 102(1)-102(3). For each identified event, the system may associate a threat level with the event. Based on the respective threat levels associated with each computing system 102(1)-102(3), the computing device 104(3) may execute the failover program 124 to determine whether any of the threat levels are sufficiently high to warrant performing a preemptive failover from one of the computing systems 102 to another one of the computing systems 102. In some cases, the failover program may include, or may access, a machine-learning model that is trained to make a decision based on the respective threat levels determined for each of the computing systems 102 for deciding whether to initiate a preemptive failover.

In this example, suppose that the local condition information 117 for the first computing system 102(1) indicates that a rolling blackout is expected to be in effect for the geographic location in which the first computing system 102(1) is located. Furthermore, suppose that the sensor information for the second computing system 102(2) indicates that a temperature associated with the second computing system is elevated, but not at a level that is sufficiently high to meet a threshold corresponding to requiring a failover. Consequently, based on determining that that threat level at the first system satisfies a condition for performing a failover from the first system, and further based on determining that threat level at the second system is lower than the threat level at the first system and does not satisfy a condition for performing a failover, the computing device 104(3) may send a failover instruction 140 to at least the first computing system 102(1) to instruct the first computing system to perform a failover workload processing to the second computing system 102(2).

As a result, the second computing system 102(2) may receive the failover from the first computing system 102(1), and may begin processing the workload that was previously processed by the first computing system 102(1). For example, the second computing system 102(2) may begin receiving and responding to requests from client devices 108 that were previously serviced by the first computing system 102(1). In addition, the second computing system 102(2) may begin replication to the third computing system 102(3), as indicated at 142, as well as performing replication back to the first computing system 102(1) so long as the first computing system 102(1) remains operational. This may reduce the time for failback to be performed from the second computing system 102(2) to the first computing system 102(1), such as when the threat of rolling blackouts has ended. Further, an example, has been described above, numerous variations will be apparent to those of skill in the art having the benefit of the disclosure herein.

FIG. 2 illustrates an example logical arrangement of the failover program 124 configured for monitoring for events and preemptively performing failover when appropriate according to some implementations herein. The failover program 124 may be executed by a computing device, such as one of the computing devices 104 at one of the computing systems 102 discussed above with respect to FIG. 1. For instance, in some examples, the failover program 124 may be executed by a computing device 104(3) at the third computing system 102(3). Alternatively, or additionally, the failover program 124 may be executed at the first computing system 102(1), the second computing system 102(2), by an administrative computing device 110, and/or by any other suitable computing device able to communicate with the computing systems 102 over the one or more networks 106.

The failover program 124 may receive a plurality of feeds of information from a plurality of sources including the sensor information from each computing system 102 and the local condition information for each computing system 102 from the information c The failover program 124 may perform a ranking of the computing systems 102 based at least in part on a likelihood of a failure occurring at each respective computing system 102(1)-102(3) discussed above with respect to FIG. 1. Each different type of data received in these respective data feeds 202 may be treated separately according to its respective type.

In the example of FIG. 2, the failover program 124 may receive a plurality of data feeds 202, such as environmental data feed 204, an Internet of things (IOT) data feed 206, and an IT systems feed 208. Additionally, as another source of information, the failover program 124 may execute an analytics engine 210. For example, the analytics engine 210 may be a trained machine-learning model and/or a heuristics model that may receive many pieces of data for use in making a determination regarding the status of each computing system 102(1)-102(3). The data received by the analytics engine for consideration may include the data received through the plurality of data feeds 204, 206, and 208, as well as other information that may be pertinent to determining whether a preemptive failover should be performed. In the case of a machine-learning model, the analytics engine may be any of numerous types of machine-learning models, such as artificial neural networks, e.g., self-organizing neural networks, recurrent neural networks, convolutional neural networks, modular neural networks, deep learning neural networks, generative adversarial network, and so forth, as well as predictive models, decision trees, classifiers, regression models, such as linear regression models, support vector machines, stochastic models, such as Markov models and hidden Markov models, and the like.

As one example, the machine-learning model may be a neural network or other suitable machine-learning model that is trained using, as training data, information obtained from a large number of past failover and non-failover situations. For example, the information may include sensor data, data feeds, environmental conditions, and numerous other data points for past failovers and non-failovers. The model is trained and validated to recognize situations that may lead to a failover. For instance, where several environmental factors or other data points individually might not normally be recognized as being of concern, the trained machine-learning model may determine that, collectively, these environmental factors and data points indicate an increased chance that an incident may occur to the extent that a threat threshold is exceeded.

The received raw data for each data feed 202 may be converted by respective external event adapters 212, 214, and 216, each of which is configured to receive a specific format of an external data feed and normalize the output for further processing. For example, suppose that the received environmental data feed 204 includes streaming weather information for each of the computing systems 102(1)-102(3) discussed above with respect to FIG. 1. The external event adapter 212 may translate the received weather data feed for each computing system 102 into a standard output, e.g., predicted outdoor temperature, predicted wind speed, predicted flooding, predicted lightning strikes, and so forth. As one example, each external event adapter may include an application programming interface (API) that may include interfaces configured for receiving certain types of data streams and translating each type of received data stream to a structured or otherwise standardized data format.

The external event adapters 212, 214,, and 216 provide their respective outputs to noise filters 222, 224, and 226, respectively. Accordingly, there may be a noise filter 222 for the environmental data, a noise filter 224 for the Internet of Things data, and a noise filter 226 for the IT systems data. For example, each noise filter 222-226 receives the standardized data as input from its associated external event adapter 212-216, respectively, and may apply defined filter rules 230 to generate information about an event. As one example, suppose that the noise filter 222 receives a temperature as standardized data from the external event adapter 212 for environmental data. Based on the data received from the corresponding external event adapter 212, and based on the value of the received temperature, and in some cases, based on changes in the temperature (or lack of changes) as compared with other recently received temperatures for the same computing system 100 to, the noise filter 222 may apply one or more of the defined filter rules 230 to determine whether an event is taking place that may be relevant to initiation of a preemptive failover. For example, the noise filter 222 may determine whether the temperature exceeds a defined temperature threshold specified by the defined filter rules 230, and if so, may determine whether the temperature has exceeded the defined temperature threshold for a specified time threshold.

The defined filter rules 230 specify the conditions in which a preemptive failover should be considered and may further attribute a severity level to each event. For example, the higher the severity level, the greater the urgency to perform a preemptive failover. The output of the noise filters 222, 224, and 226 may be provided to threat profilers 232, 234, and 236, respectively, and the output of the analytics engine 210 may be provided to the threat profiler 238 for the analytics engine output. For example, each threat profiler 232, 234, and 236 may receive an input from its corresponding noise filter 222, 224, and 226, respectively, which may include information about a detected event and a severity level for the event. Similarly, the threat profile 238 may receive the output of the analytics engine 210 which may indicate a likelihood of one or more failover events. The threat profiler may apply one or more of the defined filter rules 230 for assigning a threat profile to the identified event. For example, each threat profile assigned to a corresponding event may indicate a threat level that the associated computing system 102 is likely to fail based on the corresponding event Accordingly, each of the threat profilers 232, 234, 236, and 238 may receive and rank respective events for threat profiling and assigning a respective threat level.

The threat profilers 232-238 may provide the generated threat profiles and event information to the failover decision engine 240. The failover decision engine 240 may generate a failover instruction to initiate a failover process, as indicated at 242, based on an indicated threat level for one of the computing systems 102 indicating that failover should be performed for that computing system 102. For example, the failover decision engine 240 may generate the failover instruction to create a failover event based upon weighing the threat level at each computing system 102 in comparison with the threat levels at the other computing systems 102. In this manner, the failover decision engine 240 may ensure that the workload is hosted at the most appropriate computing system 102 based on comparing the respective current threat level for failure at each of the respective computing systems 102. Accordingly, the failover decision engine 240 is aware of the current threat level at each of the computing systems 102, and therefore can avoid performing failover from a first site having a lower threat level to a second site having a higher threat level. On the other hand, when one of the computing systems 102 has a high threat level and another computing system 102 has a low threat level, the failover decision engine 240 may preemptively initiate a pro-active failover to the system with the lower threat level.

In some examples, the failover decision engine 240 may include a trained machine-learning model such as any of the examples of machine-learning models discussed above with respect to the analytics engine 210. However in this case, rather than being trained to identify events, the failover decision engine 240 is trained to determine whether to generate a failover instruction based on receiving information about a plurality of events and corresponding threat levels of each different event for a large number of different event types and corresponding computing systems. For example, the machine-learning model may be trained and validated using training data associated with good and bad failover decisions made in the past, which is some cases may be based on both automated failovers and human-instructed failovers.

Alternatively, in other examples, the failover decision engine 240 may include a heuristics-based decision-making program that applies a plurality of heuristic rules for determining whether to generate a failover instruction. For example, a heuristics-based decision-making program may include multiple rules that indicate whether a failover should be performed, such as:
If fire alarm is active for more than 30 seconds then assume there is a fire
If power loss is detected then priority is “high”
If power loss is detected and UPS battery is less than 25 percent, then priority is “critical”
If seasonal statistics show high usage period and computer cluster capacity less than 80 percent then priority is “medium” (e.g., if several machines in a cluster are down and Black Friday sales will start in two hours, perform failover to another site). Numerous other heuristics rules will be apparent to those of skill in the art having the benefit of the disclosure herein.

The failover program 124 is able to make an informed decision regarding whether to perform a preemptive failover based on a comparison of the current threat level at each of the computing systems that are being monitored by the failover program 124. For example, this allows a primary computing system to position the workload at the computing system having the most consistent state for ensuring no data losses. Furthermore, the failover program 124 may reduce or eliminate outages, such as the inability for users to access data that might otherwise occur due to a failure at a computing system that results in a reactive failover and corresponding switchover time. Accordingly, the preemptive failover techniques herein may be performed based at least in part on ranking the relative threat levels at each of the computing systems being monitored, and can thereby avoid having a failover performed to a computing system with an equal or greater threat level.

In addition, following recovery, the primary system herein is aware that a failover process was performed to another computing system, which can remove the complication of potentially having two systems that believe they are currently the primary system for performing the workload. For example this complication can be especially problematic if connectivity has not yet been reestablished between the primary computing system and the and the computing system that was the target of receiving the failover. Furthermore, in some examples, the techniques herein may be extended to account for staff unavailability, cost of services, balancing workloads, and/or managing geographic peak workload demands.

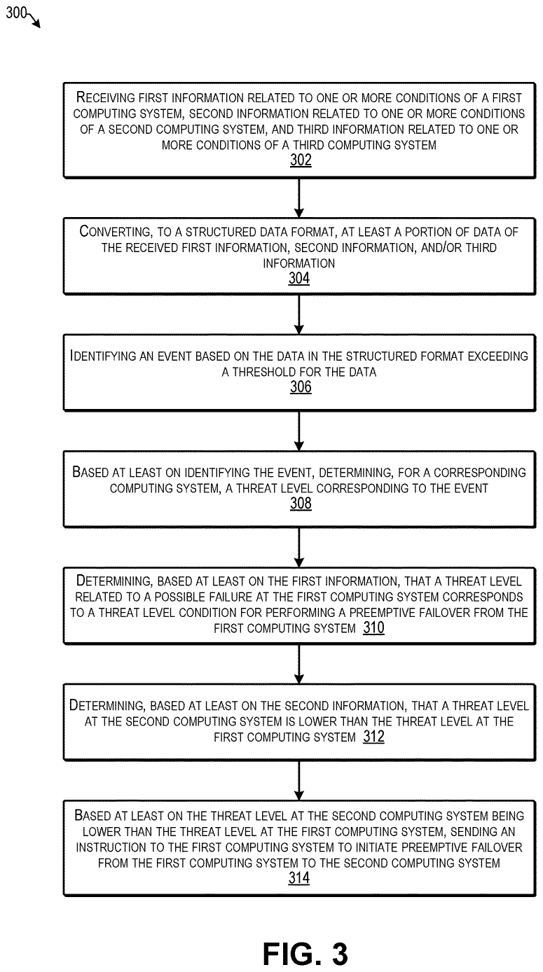

FIG. 3 is a flow diagram illustrating an example process 300 for preemptively performing failover according to some implementations. The process is illustrated as a collection of blocks in a logical flow diagram, which represents a sequence of operations, some or all of which may be implemented in hardware, software or a combination thereof. In the context of software, the blocks may represent computer-executable instructions stored on one or more computer-readable media that, when executed by one or more processors, program the processors to perform the recited operations. Generally, computer-executable instructions include routines, programs, objects, components, data structures and the like that perform particular functions or implement particular data types. The order in which the blocks are described should not be construed as a limitation. Any number of the described blocks can be combined in any order and/or in parallel to implement the process, or alternative processes, and not all of the blocks need be executed. For discussion purposes, the process is described with reference to the environments, frameworks, and systems described in the examples herein, although the process may be implemented in a wide variety of other environments, frameworks, and systems. In some cases, the process 300 may be executed at least in part by a computing device, such as at one or more of the computing systems 102 or by any other suitable computing device able to communicate with the computing systems 102.

At 302, the computing device may receive first information related to one or more conditions of a first computing system, second information related to one or more conditions of a second computing system, and third information related to one or more conditions of a third computing system.

At 304, the computing device may convert, to a structured data format, at least a portion of data of the received first information, second information, and/or third information.

At 306, the computing device may identify an event based on the data in the structured format exceeding a threshold for the data.

At 308, based at least on identifying the event, the computing device may determine, for a corresponding computing system, a threat level corresponding to the event.

At 310, based at least on the first information, the computing device may determine that a threat level related to a possible failure at the first computing system corresponds to a threat level condition for performing a preemptive failover from the first computing system.

At 312, based at least on the second information, the computing device may determine that a threat level at the second computing system is lower than the threat level at the first computing system.

At 314, based at least on the threat level at the second computing system being lower than the threat level at the first computing system, the computing device may send an instruction to the first computing system to initiate preemptive failover from the first computing system to the second computing system.

The example processes described herein are only examples of processes provided for discussion purposes. Numerous other variations will be apparent to those of skill in the art in light of the disclosure herein. Additionally, while the disclosure herein sets forth several examples of suitable frameworks, architectures and environments for executing the processes, implementations herein are not limited to the particular examples shown and discussed. Furthermore, this disclosure provides various example implementations, as described and as illustrated in the drawings. However, this disclosure is not limited to the implementations described and illustrated herein, but can extend to other implementations, as would be known or as would become known to those skilled in the art.

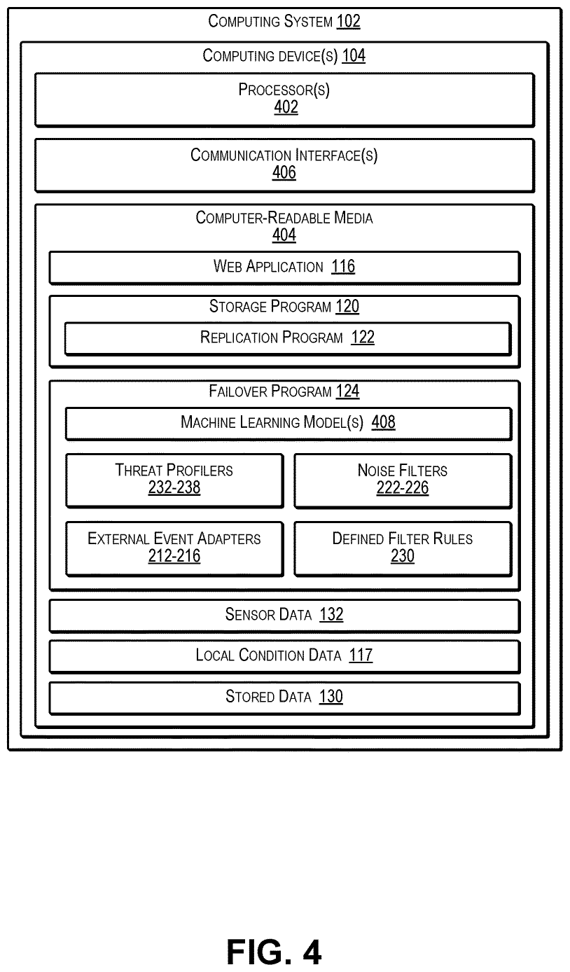

FIG. 4 illustrates select components of an example computing system 102 that may be used to implement some of the functionality of the systems described herein. The computing system 102 includes the one or more computing devices 104, which may include one or more servers or other types of computing devices that may be embodied in any number of ways. Additionally, in some examples, the computing devices 104 may also include, or may be in communication with, one or more storage systems, storage controllers, network attached storage, storage arrays, storage area networks, or the like, for storing the stored data 130. For instance, in the case of a server, the programs, other functional components, and data may be implemented on a single server, a cluster of servers, a server farm or data center, a cloud-hosted computing service, and so forth, although other computer architectures may additionally or alternatively be used. Multiple computing devices 104 may be located together or separately, and organized, for example, as virtual servers, server banks, and/or server farms. The described functionality may be provided by the servers of a single entity or enterprise, or may be provided by the servers and/or services of multiple different entities or enterprises.

In the illustrated example, the computing devices 104 include, or may have associated therewith, one or more processors 402, one or more computer-readable media 404, and one or more communication interfaces 406. Each processor 402 may be a single processing unit or a number of processing units, and may include single or multiple computing units, or multiple processing cores. The processor(s) 402 can be implemented as one or more central processing units, microprocessors, microcomputers, microcontrollers, digital signal processors, graphics processing units, system-on-chip processors, state machines, logic circuitries, and/or any devices that manipulate signals based on operational instructions. As one example, the processor(s) 402 may include one or more hardware processors and/or logic circuits of any suitable type specifically programmed or configured to execute the algorithms and processes described herein. The processor(s) 402 may be configured to fetch and execute computer-readable instructions stored in the computer-readable media 404, which may program the processor(s) 402 to perform the functions described herein.

The computer-readable media 404 may include volatile and nonvolatile memory and/or removable and non-removable media implemented in any type of technology for storage of information, such as computer-readable instructions, data structures, program modules, or other data. For example, the computer-readable media 404 may include, but is not limited to, RAM, ROM, EEPROM, flash memory or other memory technology, optical storage, solid state storage, magnetic tape, and magnetic disk storage, or any other medium that can be used to store the desired information and that can be accessed by a computing device. Further, in some examples, the computer-readable media 404 includes network storage systems, which may include storage arrays, network attached storage, storage area networks, cloud storage, and the like.

Depending on the configuration of the computing systems 102, the computer-readable media 404 may be a tangible non-transitory medium to the extent that, when mentioned, non-transitory computer-readable media exclude media such as energy, carrier signals, electromagnetic waves, and/or signals per se. In some cases, the computer-readable media 404 may be at the same location as the computing system 102, while in other examples, the computer-readable media 404 may be partially remote from the computing system 102.

The computer-readable media 404 may be used to store any number of functional components that are executable by the processor(s) 402. In many implementations, these functional components comprise instructions or programs that are executable by the processor(s) 402 and that, when executed, specifically program the processor(s) 402 to perform the actions attributed herein to the computing system 102. Functional components stored in the computer-readable media 404 may include the web application 116, the storage program 120, including the replication program 122, and the failover program 124, each of which may include one or more computer programs, applications, modules, executable code, or portions thereof. Further, while these programs are illustrated together in this example, in some examples these programs may be separate programs and/or during use, some or all of these programs may be executed on separate computing devices 104 at a respective computing system 102.

As discussed above, in some examples, the failover program 124 may include or may access one or more machine-learning models 408 that may be trained to perform the functions discussed above for the analytics engine 210 and/or the failover decision engine 240. In addition, the failover program 124 may include or may access the external event adapter 212-216, the noise filters 222-226, the threat profilers 232-238, and the defined filter rules 230.

In addition, the computer-readable media 404 may store data, data structures, and other information used for performing the functions and services described herein. For example, the computer-readable media 404 may store one or more data structures that contain, at least temporarily, the sensor data 132 and the local condition data 117. The computer readable media 404 may also store the stored data 130, such as in one or more storage systems or other storage devices as discussed above.

The computing system 102 may also include or maintain other functional components and data, which may include programs, drivers, etc., and the data used or generated by the functional components. Further, the computing system 102 may include many other logical, programmatic, and physical components, of which those described herein are merely examples that are related to the discussion herein.

The one or more communication interfaces 406 may include one or more software and hardware components for enabling communication with various other devices, such as over the one or more network(s) 106. For example, the communication interface(s) 406 may enable communication through one or more of a LAN, the Internet, cable networks, cellular networks, wireless networks (e.g., Wi-Fi) and wired networks (e.g., Fibre Channel, fiber optic, Ethernet), direct connections, as well as close-range communications such as BLUETOOTH®, and the like, as additionally enumerated elsewhere herein.

Various instructions, methods, and techniques described herein may be considered in the general context of computer-executable instructions, such as computer programs and applications stored on computer-readable media, and executed by the processor(s) herein. Generally, the terms program and application may be used interchangeably, and may include instructions, routines, scripts, modules, objects, components, data structures, executable code, etc., for performing particular tasks or implementing particular data types. These programs, applications, and the like, may be executed as native code or may be downloaded and executed, such as in a virtual machine or other just-in-time compilation execution environment. Typically, the functionality of the programs and applications may be combined or distributed as desired in various implementations. An implementation of these programs, applications, and techniques may be stored on computer storage media or transmitted across some form of communication media.

Although the subject matter has been described in language specific to structural features and/or methodological acts, it is to be understood that the subject matter defined in the appended claims is not necessarily limited to the specific features or acts described. Rather, the specific features and acts are disclosed as example forms of implementing the claims.

1. A system comprising:
one or more processors configured by executable instructions to receive information related to a first computing system and a second computing system, wherein the first computing system is able to communicate over a network with the second computing system, the one or more processors configured to perform operations comprising:
receiving, by the one or more processors, first information related to one or more conditions of the first computing system and second information related to one or more conditions of the second computing system;
determining, by the one or more processors, based at least on the first information, that a threat level related to a possible failure at the first computing system corresponds to a threat level condition for performing a preemptive failover from the first computing system;
determining, by the one or more processors, based at least on the second information, that a threat level at the second computing system is lower than the threat level at the first computing system; and
based at least on determining that the threat level at the second computing system is lower than the threat level at the first computing system, sending, by the one or more processors, an instruction to the first computing system to initiate preemptive failover from the first computing system to the second computing system.

2. The system as recited in claim 1, wherein the first information related to the one or more conditions of the first computing system includes sensor data received from a plurality of sensors associated with the first computing system.

3. The system as recited in claim 1, wherein the first information related to the one or more conditions of the first computing system includes local condition information received from a computing device over a network, the local condition information including at least one of a local weather forecast for a location of the first computing system or information related to events occurring in proximity to the location of the first computing system.

4. The system as recited in claim 1, wherein the first information related to the one or more conditions of the first computing system includes at least one of staffing unavailability information related to the first computing system, a software breach related to the first computing system, or a hardware breach related to the first computing system.

5. The system as recited in claim 1, the operations further comprising:
converting, to a structured format, at least a portion of data of the received first information related to one or more conditions of the first computing system; and
identifying an event based on the portion of data in the structured format exceeding a threshold for the data.

6. The system as recited in claim 5, the operations further comprising:
based at least on identifying the event based on the portion of data in the structured format exceeding a threshold for the data, determining, for the first computing system, a threat level corresponding to the event.

7. The system as recited in claim 1, further comprising a machine-learning model trained to determine to send the instruction to the first computing system to initiate the preemptive failover from the first computing system to the second computing system based at least on determining that the threat level at the second computing system is lower than the threat level at the first computing system.

8. The system as recited in claim 1, the operations further comprising determining the threat level related to the possible failure at the first computing system based at least on a plurality of defined rules including a plurality of thresholds corresponding to a plurality of the conditions of the first computing system.

9. The system as recited in claim 1, wherein sending the instruction to the first computing system to initiate preemptive failover from the first computing system to the second computing system causes, at least in part, the first computing system to transfer a processing workload to the second computing system.

10. The system as recited in claim 9, wherein, following transfer of the processing workload to the second computing system, the second computing system replicates data related to the workload to a third computing system and to the first computing system.

11. The system as recited in claim 1, wherein the operation of determining that the threat level at the second computing system is lower than the threat level at the first computing system further comprises determining that the threat level at the second computing system does not correspond to a threat level condition for performing preemptive failover from the second computing system.

12. A method comprising:
receiving, by one or more processors, first information related to one or more conditions of a first computing system and second information related to one or more conditions of a second computing system, wherein the first computing system is able to communicate over a network with the second computing system;
determining, by the one or more processors, based at least on the first information, that a threat level related to a possible failure at the first computing system corresponds to a threat level condition for performing a preemptive failover from the first computing system;
determining, by the one or more processors, based at least on the second information, that a threat level at the second computing system is lower than the threat level at the first computing system; and
based at least on determining that the threat level at the second computing system is lower than the threat level at the first computing system, sending, by the one or more processors, an instruction to the first computing system to initiate preemptive failover from the first computing system to the second computing system.

13. The method as recited in claim 12, wherein the first information related to the one or more conditions of the first computing system includes at least one of:
sensor data received from a plurality of sensors associated with the first computing system;
local condition information received from a computing device over a network, the local condition information including at least one of a local weather forecast for a location of the first computing system or information related to events occurring in proximity to the location of the first computing system;
staffing unavailability information related to the first computing system;
information related to a software breach at the first computing system; or
information related to a hardware breach at the first computing system.

14. A non-transitory computer readable medium storing instructions executable by one or more processors to cause the one or more processors to perform operations comprising:
receiving, by the one or more processors, first information related to one or more conditions of a first computing system and second information related to one or more conditions of a second computing system, wherein the first computing system is able to communicate over a network with the second computing system;
determining, by the one or more processors, based at least on the first information, that a threat level related to a possible failure at the first computing system corresponds to a threat level condition for performing a preemptive failover from the first computing system;
determining, by the one or more processors, based at least on the second information, that a threat level at the second computing system is lower than the threat level at the first computing system; and
based at least on determining that the threat level at the second computing system is lower than the threat level at the first computing system, sending, by the one or more processors, an instruction to the first computing system to initiate preemptive failover from the first computing system to the second computing system.

15. The non-transitory computer readable medium as recited in claim 14, wherein the first information related to the one or more conditions of the first computing system includes at least one of:
sensor data received from a plurality of sensors associated with the first computing system;
local condition information received from a computing device over a network, the local condition information including at least one of a local weather forecast for a location of the first computing system or information related to events occurring in proximity to the location of the first computing system;
staffing unavailability information related to the first computing system;
information related to a software breach at the first computing system; or
information related to a hardware breach at the first computing system.
